(19) United States
(12) Patent Application Publication
(10) Pub. No.: US 2023/0256632 A1
(43) Pub. Date: Aug. 17, 2023

(54) 2-IN-1 MODULAR GROOMING DEVICE

(71) Applicant: Walker & Co. Brands, Inc., Palo Alto, CA (US)

(72) Inventors: Tristan WALKER, Atlanta, GA (US); Jimmy JIA, Atlanta, GA (US); Martin BONE, Cornwall on Hudson, NY (US)

(21) Appl. No.: 17/673,859

(22) Filed: Feb. 17, 2022

(51) Int. Cl. B26B 19/10; B26B 19/20; B26B 19/38

(52) U.S. Cl. CPC B26B 19/10; B26B 19/205; B26B 19/3853; B26B 19/388

(57) ABSTRACT

An electric-powered trimmer includes a cutting assembly having a stationary blade. A moveable blade is positioned on the stationary blade such that a cutting gap is defined between the moveable blade and the stationary blade. The moveable blade is configured to move along a first axis and a second axis extending orthogonal to the first axis. An adjustment mechanism is operable to move the moveable blade along the second axis relative to the stationary blade to selectively change the size of the cutting gap.

### TECHNICAL FIELD

The present invention is directed to a grooming device and, more particularly, to a 2-in-1 modular grooming device.

### BACKGROUND

In general, barbers and hairstylists use electric trimmers when trimming hair. Electric trimmers may also be used by individuals for personal care and grooming purposes. Electric trimmers may be used to cut hair for a variety of purposes, including, but not limited to, shaving, shaping beards and mustaches, and trimming hair generally.

### SUMMARY

The present disclosure includes one or more of the features recited in the appended claims and/or the following features which, alone or in any combination, may comprise patentable subject matter.

According to a first aspect of the disclosed embodiments, an electric-powered modular grooming device includes a handle. An electrical circuit is positioned in the handle and includes a primary motor having a primary drive shaft. At least two cutting assemblies are removeably coupled to the handle. The at least two cutting assemblies include a clipper and a trimmer. Each of the at least two cutting assemblies includes a stationary blade. A moveable blade is positioned on the stationary blade such that a cutting gap is defined between the moveable blade and the stationary blade. The moveable blade is configured to move along a first axis and a second axis extending orthogonal to the first axis. A drive mechanism is connected between the primary drive shaft and the moveable blade to move the moveable blade relative to the stationary blade along the first axis. The electrical circuit includes an adjustment mechanism positioned in the handle. The adjustment mechanism includes a secondary motor having a secondary drive shaft coupled to the moveable blade and operable to move the moveable blade along the second axis relative to the stationary blade to selectively change the size of the cutting gap.

In some embodiments of the first aspect, the electrical circuit may include at least one button configured to actuate the adjustment mechanism to move the moveable blade along the second axis. The size of the cutting gap may be adjustable within a range of 0.0 mm to 2.5 mm. The size of the cutting gap may be adjustable in 0.1 mm increments. The electrical circuit may include a display positioned in the handle to illustrate a number corresponding to the size of cutting gap. At least one guard may couple to the cutting assembly. A magnetic connector may be positioned on the cutting assembly. The at least one guard may couple to the magnetic connector. The electrical circuit may include a motion detection device positioned in the handle. The electrical circuit may be activated when the motion detection device detects movement of the handle. The motion detection device may be an accelerometer. A battery pack may be positioned in the handle and may be electrically connected with the electrical circuit for providing electrical power to the electrical circuit.

According to a second aspect of the disclosed embodiments, an electric-powered modular grooming device includes a handle. A primary motor has a primary drive shaft. A plurality of cutting assemblies is removeably coupled to the handle. Each of the plurality of cutting assemblies includes a first blade. A second blade is positioned on the first blade such that a cutting gap is defined between the second blade and the first blade. The second blade is configured to move in a first direction and a second direction that is different from the first direction. A drive mechanism is connected between the primary drive shaft and the second blade to move the second blade relative to the first blade in the first direction. An adjustment mechanism is positioned in the handle. The adjustment mechanism includes a secondary motor having a secondary drive shaft coupled to the second blade and operable to move the second blade in the second direction to selectively change the size of the cutting gap. At least one button is configured to actuate the adjustment mechanism to move the second blade in the second direction to change the size of the cutting gap.

In some embodiments of the second aspect, the plurality of cutting assemblies may include a clipper and a trimmer. The size of the cutting gap may be adjustable within a range of 0.0 mm to 2.5 mm. The size of the cutting gap may be adjustable in 0.1 mm increments. A plurality of cutting assemblies may be provided. Each of the plurality of cutting assemblies may be removeably attachable to the handle. A display may be positioned in the handle to illustrate a number corresponding to the size of cutting gap. At least one guard may couple to the cutting assembly. A magnetic connector may be positioned on the cutting assembly. The at least one guard may couple to the magnetic connector. A motion detection device may be positioned in the handle. The trimmer may be activated when the motion detection device detects movement of the handle. A battery pack may be positioned in the handle for providing electrical power to the trimmer. A display in the handle may indicate an amount of electrical power remaining in the battery.

According to a third aspect of the disclosed embodiments, an electric-powered modular grooming device includes a handle. An electrical circuit is positioned in the handle and includes a primary motor having a primary drive shaft. A plurality of cutting assemblies are interchangeably attachable to the handle. Each of the plurality of cutting assemblies includes a stationary blade. A moveable blade is positioned on the stationary blade such that a cutting gap is defined between the moveable blade and the stationary blade. The moveable blade is configured to move along a first axis and a second axis extending orthogonal to the first axis. A drive mechanism is connected between the primary drive shaft and the moveable blade to move the moveable blade relative to the stationary blade along the first axis. The electrical circuit includes an adjustment mechanism positioned in the handle. The adjustment mechanism includes a secondary motor having a secondary drive shaft coupled to the moveable blade and operable to move the moveable blade along the second axis relative to the stationary blade to selectively change the size of the cutting gap. A first button is configured to actuate the adjustment mechanism to move the moveable blade along the second axis to increase the size of the cutting gap. A second button is configured to actuate the adjustment mechanism to move the moveable blade along the second axis to decrease the size of the cutting gap. In some embodiments of the third aspect, the plurality of cutting assemblies may include a clipper and a trimmer.

Additional features, which alone or in combination with any other feature(s), such as those listed above and/or those listed in the claims, can comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures in which:

FIG. 1 is a top exploded view of an electric-powered modular grooming device including a plurality of cutting assemblies that are interchangeably attachable to a handle.

FIG. 2 is a bottom plan view of the handle shown in FIG. 1;

FIG. 3 is a top plan view of the handle shown in FIG. 1;

FIG. 4 is a cross-sectional view of the handle taken about the line 4-4 shown in FIG. 1;

FIG. 5 is a schematic view of an electrical circuit for the electric-powered modular grooming device shown in FIG. 1;

FIG. 6 is a top plan view of the electric-powered modular grooming device shown in FIG. 1 having a cutting assembly attached to the handle;

FIG. 7 is a top plan view of a cutting assembly in accordance with an embodiment and configured as a trimmer;

FIG. 8 is a cross-sectional view of the cutting assembly taken along the line 8-8 shown in FIG. 7;

FIG. 9 is a top plan view of a cutting assembly in accordance with another embodiment and configured as another trimmer;

FIG. 10 is a cross-sectional view of the cutting assembly taken along the line 10-10 shown in FIG. 9;

FIG. 11 is a top plan view of a cutting assembly in accordance with yet another embodiment and configured as a clipper;

FIG. 12 is a cross-sectional view of the cutting assembly taken along the line 12-12 shown in FIG. 11;

FIG. 13 is a bottom plan view of the cutting assembly shown in FIG. 11; and

FIG. 14 is a side perspective view of the cutting assembly shown in FIG. 11 and having a guard coupled thereto.

### DETAILED DESCRIPTION

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

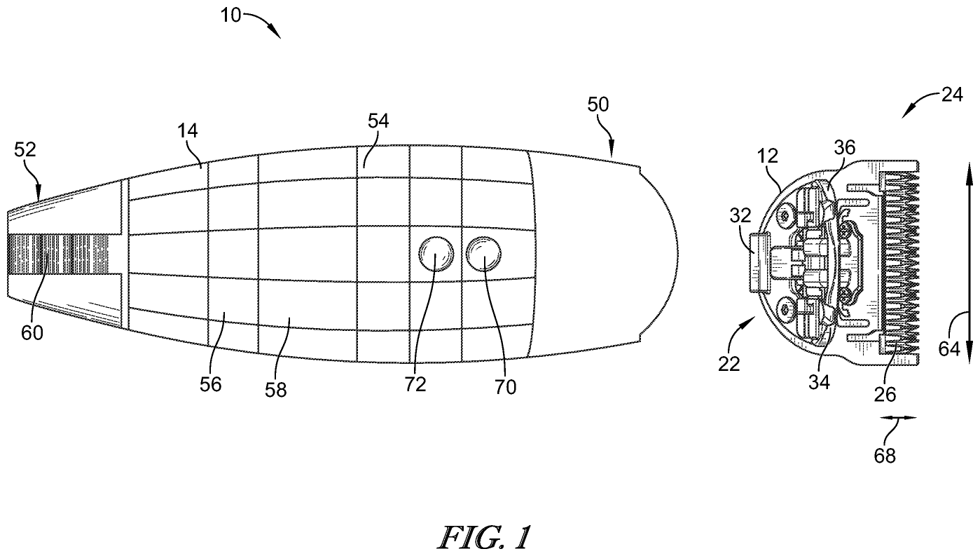

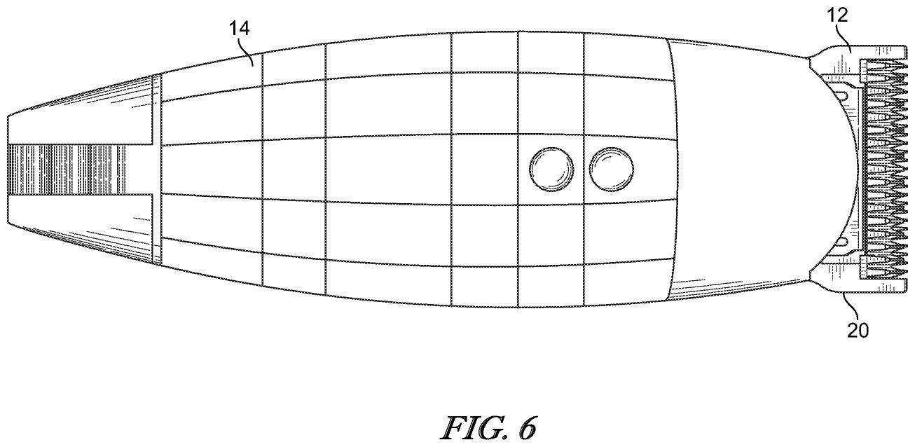

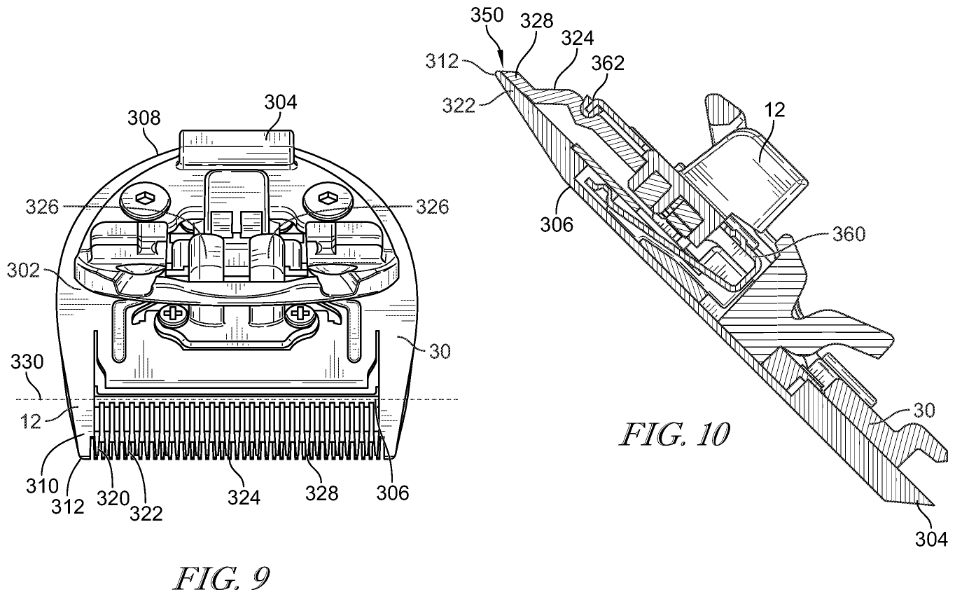

Referring to FIG. 1, an electric-powered modular grooming device 10 includes a plurality of interchangeable cutting assemblies 12 that are interchangeably attachable to an elongated handle 14, as illustrated in FIG. 6. The plurality of interchangeable cutting assemblies 12 includes a trimmer 20 (shown in FIGS. 6-8), a trimmer 30 (shown in FIGS. 9-10), and a clipper 40 (shown in FIGS. 11-14). The trimmers 20 and 30 are designed for light trimming and detailing, for example, trimming beards, sideburns, nasal hair and more. The trimmers 20 and 30 include a tooth and blade size appropriate for cuts that are closer to the skin. The trimmers 20 and 30 can be a viable replacement for a razor because the trimmers 20 and 30 have thinner blades that can be used safely near the skin. The trimmers 20 and 30 can include hypoallergenic blades for users with sensitive skin. The clipper 40 is designed to cut longer lengths of hair. The clipper 40 can include a number of guide combs that or guards (described in more detail below) that clip onto the clipper 40. These guards can range from 1/16 inches up to 1.5 inches. The trimmer 20, trimmer 30, and clipper 40 interchangeably snap onto the handle 14 to provide a 2-in-1 grooming device 10 that can be used from trimming and/or clipping. It will be appreciated that other cutting assemblies 12 may be interchangeably coupled to the handle 14.

The handle 14 extends from a distal end 50 to a proximal end 52. The detachable cutting assembly 12 is coupled to the distal end 50. The handle 14 includes an outer surface 54 that extends proximally from the distal end 50 to the proximal end 52. In the illustrative embodiment, the entire outer surface 54 is defined by a plurality of facets 56. Each facet 56 includes a planar surface 58 that is angled relative to the other facets 56. It should be appreciated that in other embodiments the each facet may include a curved surface. In still other embodiments, the part or all of the outer surface of the handle may be formed as a single continuous surface without any facets. The surface of each facet 56 is textured to facilitate gripping the handle 14 by the user. The handle 14 is formed from a plastic material to provide the texture. It should be appreciated that in other embodiments the outer surface 30 may be formed from any material.

A power button 60 is positioned at the proximal end 52 of the handle 14. In some embodiments, the power button 60 is utilized to turn the grooming device 10 on and off. In other embodiments (described in more detail below), the grooming device 10 is activated by motion and the power button 60 only activates the cutting assembly 12. For example, in some embodiments, the power button includes a first “off” mode; a second “stand-by” mode, wherein power is supplied to the grooming device 10; and a third “on” mode, wherein the cutting assembly 12 is activated. In other embodiments, the grooming device 10 is powered and enters the “stand-by” mode after motion of the grooming device 10 is detected, and the grooming device 10 enters the “on” mode to activate the cutting assembly 12 upon activation of the power button 60.

The cutting assembly 12 includes a proximal end 22 and a distal end 24 having cutting blades 26. At least one of the cutting blades 26 is configured to move back and forth in each direction along a first axis 64 to trim or cut hair. An adjustment mechanism (described in more detail below) is operable to move at least one of the cutting blades 26 of the cutting assembly 12 back and forth in each direction along a second axis 68 to selectively change the size of a cutting gap of the cutting assembly 12. A direction of the first axis 64 is different than a direction of the second axis 68. The second axis 68 is orthogonal to the first axis 64. The second axis 68 is substantially perpendicular to the first axis 64. A first button 70 positioned on the handle 14 actuates the adjustment mechanism to increase the size of the cutting gap. A second button 72 positioned on the handle 14 actuates the adjustment mechanism to decrease the size of the cutting gap.

The cutting assembly 12 includes a mounting flange 32 positioned on the proximal end 22 of the cutting assembly 12. The mounting flange 32 is configured to couple to the handle 14. A mounting bracket 34 extends from the cutting assembly 12 between the proximal end 22 and the distal end 24. The mounting bracket 34 includes an arched bar 36 for securing the cutting assembly to the handle 14.

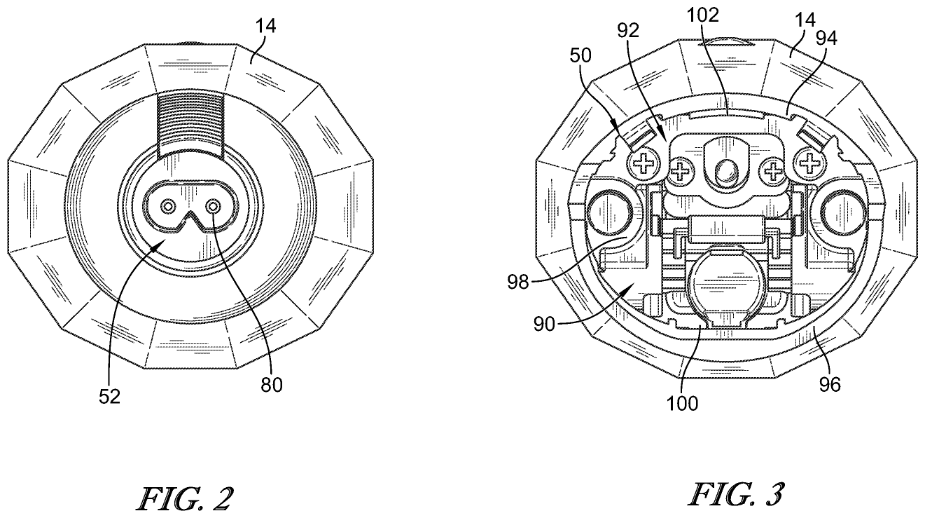

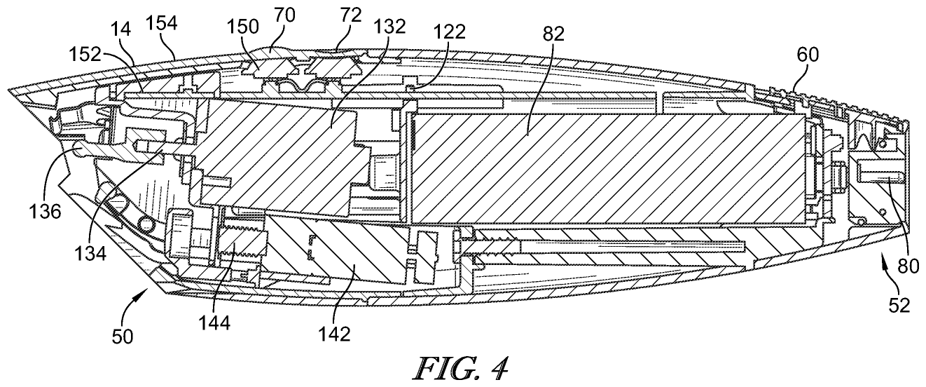

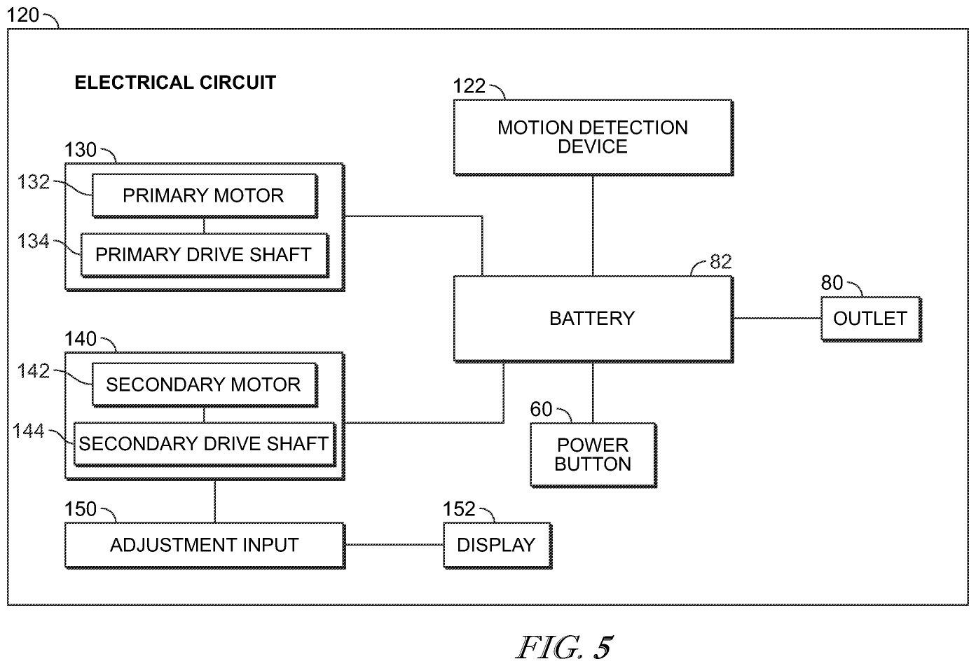

Referring now to FIG. 2, the proximal end 52 of the handle 14 includes a power socket 80, which is sized to receive a plug defined at one end of an electrical cord (not shown). The electrical cord has a plug defined at its opposite end that is configured to be received in a standard wall outlet. The power socket 80 is electrically coupled to a battery pack 82 (shown in FIGS. 4 and 5) that is positioned in the handle 14. In that way, the grooming device 10 may be powered directly from a wall outlet when the electrical charge of the battery pack 82 is low or at the user's discretion.

Referring to FIG. 3 the distal end 50 of the elongated handle 14 has the receptacle 90 defined therein. In the illustrative embodiment, the receptacle 90 extends inwardly from a distal opening 92. An inner wall 94 extends inwardly from a rim 96 that defines the opening 92 to a base wall 98. The walls 94 and 98 cooperate to define the receptacle 90. A central slot 100 (shown in FIG. 4) is defined in the rim 96. The slot 100 is rectangular and is sized to receive the mounting flange 32 of the cutting assembly 12. The handle 14 also has a groove 102 defined in the inner wall 94 opposite the central slot 100. The groove 102 is arch-shaped and is sized to receive the arched bar 36 of a mounting bracket 34. When the arched bar 36 is positioned in the groove 102, the walls of the groove 102 grip the arched bar 36 to secure the cutting assembly 12 to the handle 14. A pair of stop flanges 104 extend inwardly from the inner wall 94 to prevent the arched bar 36 from advancing beyond the groove 102.

Referring now to FIGS. 4-5, the handle 14 houses all of the electrical circuitry 120 of the grooming device 10. The electrical circuitry 120 includes the battery pack 82 electrically coupled to the power socket or outlet 80 and the power button 60. The battery pack 82 powers the electrical circuitry 120. A motion detection device 122 is electrically coupled to the battery pack 82. In some embodiments the motion detection device 122 is an accelerometer that detects movement of the handle 14. Upon detecting movement of the handle 14, the electrical circuitry 120 is activated so that power is supplied to the grooming device 10.

The electrical circuitry 120 includes a cutting mechanism 130 having an electric primary motor 132 that is coupled to a primary drive shaft 134. The primary drive shaft 134 includes a cam 136 coupled to the cutting blades 26 and configured to move at least one of the cutting blades 26 in the first direction 62 along the first axis 64 to trim or cut hair when the primary motor 132 is activated. An adjustment mechanism 140 includes an electric secondary motor 142 that is coupled to a secondary drive shaft 144. The secondary drive shaft 144 is operable to move at least one of the cutting blades 26 of the cutting assembly 12 in the second direction 66 along the second axis 68 to selectively change the size of the cutting gap of the cutting assembly 12 when the secondary motor 142 is activated. The size of the cutting gap is adjustable within a range of 0.0 mm to 2.5 mm. in 0.1 mm increments.

An adjustment input 150 includes the first button 70 and the second button 72. The adjustment input 150 is configured to actuate the secondary motor 142 to selectively change the size of the cutting gap. A display 152 is positioned adjacent the adjustment input 150. The display 152 includes at least one light emitter, e.g. at least one light emitting diode, that is visible through a transparent panel 154 in the handle 14. The display 152 illustrates a number indicative of the size of the cutting gap. For example, if the size of the cutting gap is adjusted to 0.5 mm, the display 152 will display the number “0.5”. The display 152 also illustrates a light bar that indicates an amount of power remaining in the battery pack 82.

In some embodiments, the grooming device 10 enters the “stand-by” mode after motion of the grooming device 10 is detected by the motion detection device 122. In the “stand-by” mode, the display 152 is illuminated. Additionally, in the “stand-by” mode, the adjustment mechanism 140 receives power so that the adjustment input 150 can operate the secondary motor 142 to adjust the size of the cutting gap. The grooming device 10 enters the “on” mode to activate the cutting mechanism 130 upon activation of the power button 60.

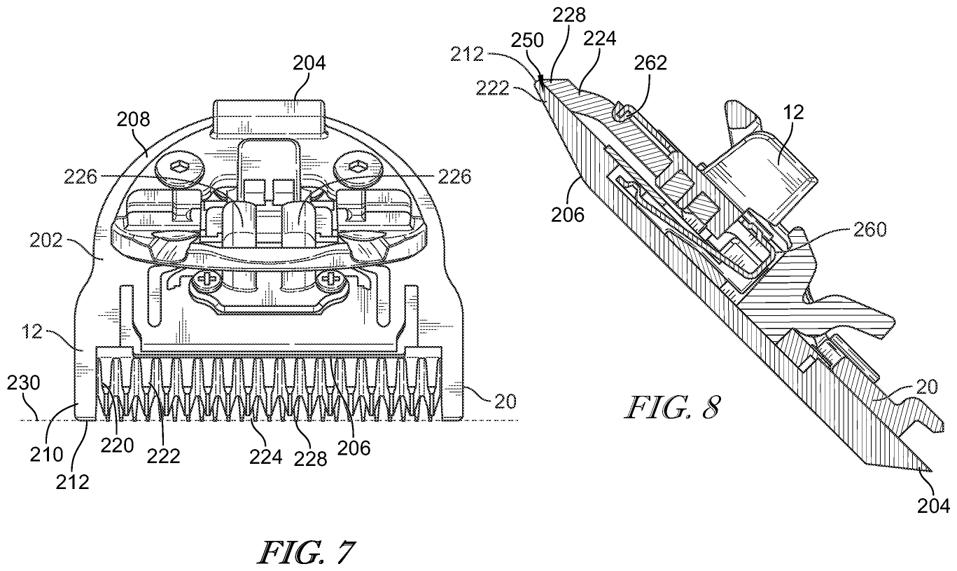

Referring now to FIGS. 7-8, the cutting assembly 20 is configured as a trimmer. The cutting assembly 20 includes an outer body 202 that is sized to cover the distal receptacle 90 when the cutting assembly 20 is attached to the handle 14. In the illustrative embodiment, the outer body 202 is formed as a single monolithic component from a metallic material such as, for example, stainless steel. The outer body 202 includes a planar proximal surface 204, a planar distal surface 206, and a curved outer wall 208 that extends between the surfaces 204 and 206. The outer body 202 also includes a connecting surface 210 that extends away from the distal surface 206 to a front edge 212 of the outer body 202. In the illustrative embodiment, the connecting surface 210 is substantially planar, but it should be appreciated that in other embodiments it may be curved.

The outer body 202 of the assembly 200 also has a plurality of cutting teeth 220 defined along the front edge 212. Each cutting tooth 220 of the body 202 extends forward from a base to a pointed, cantilevered tip, and the teeth 220 cooperate to define a stationary blade 222, which is not moved by any of the electric motors during a trimming operation. The cutting assembly 20 also includes a moveable blade 224 having a cam follower 226 that is coupled to the cam 136 to move the moveable blade 224 back and forth in each direction along the first axis 64 with the primary motor 132 during the trimming operation. In the illustrative embodiment, the blade 224 is also attached to the adjustment mechanism 140, which may be operated by the user between trimming operations to move the moveable blade 224 back and forth in each direction along the second axis 68 adjust the separation or cutting gap between the blades 222 and 224 and hence adjust the amount of hair removed by the grooming device 10.

Similar to the stationary blade 222, the moveable blade 224 has a plurality of cutting teeth 228 defined extending forward from a base to a pointed, cantilevered tip. The tips of the cutting teeth 228 cooperate to define an imaginary cutting line 230 extending laterally across the front edge 212 of the outer body 202. In some embodiments, the cutting teeth 220 and 228 may include protective coatings. In another embodiment, the distal planar surface 206 of the cutting assembly 20 includes protective coatings. The protective coatings may be lubricious, hydrophobic, and oleophobic. In one embodiment, the coating may be a non-volatile organic compound (non-VOC) silicate, non-polytetrafluoroethylene (non-PTFE), high-temperature release coating used for stainless steel and other metallic surfaces. Similar to the outer body 202, the moveable blade 224 is formed as a single monolithic component from a metallic material such as, for example, stainless steel. A cutting gap 250 (described above) is defined between the moveable blade 224 and the stationary blade 222.

The cutting assembly 20 also includes a biasing element—in this case, a spring 260—that is configured to bias the moveable blade 224 into engagement with the outer body 202 (and hence the stationary blade 222). The spring 260 includes a pair of legs 262 that provide a downward force on the moveable blade 224 and urge the blade 224 into contact with the outer body 202.

Referring now to FIGS. 9-10, the cutting assembly 30 is configured as another trimmer. The cutting assembly 30 includes an outer body 302 that is sized to cover the distal receptacle 90 when the cutting assembly 30 is attached to the handle 14. In the illustrative embodiment, the outer body 302 is formed as a single monolithic component from a metallic material such as, for example, stainless steel. The outer body 302 includes a planar proximal surface 304, a planar distal surface 306, and a curved outer wall 308 that extends between the surfaces 304 and 306. The outer body 302 also includes a connecting surface 310 that extends away from the distal surface 306 to a front edge 312 of the outer body 302. In the illustrative embodiment, the connecting surface 310 is substantially planar, but it should be appreciated that in other embodiments it may be curved.

The outer body 302 of the assembly 300 also has a plurality of cutting teeth 320 defined along the front edge 312. Each cutting tooth 320 of the body 302 extends forward from a base to a pointed, cantilevered tip, and the teeth 320 cooperate to define a stationary blade 322, which is not moved by any of the electric motors during a trimming operation. The cutting assembly 30 also includes a moveable blade 324 having a cam follower 326 that is coupled to the cam 136 to move the moveable blade 324 back and forth in each direction along the first axis 64 with the primary motor 132 during the trimming operation. In the illustrative embodiment, the blade 324 is also attached to the adjustment mechanism 140, which may be operated by the user between trimming operations to move the moveable blade 324 back and forth in each direction along the second axis 68 adjust the separation or cutting gap between the blades 322 and 324 and hence adjust the amount of hair removed by the grooming device 10.

Similar to the stationary blade 322, the moveable blade 324 has a plurality of cutting teeth 328 defined extending forward from a base to a pointed, cantilevered tip. The tips of the cutting teeth 328 cooperate to define an imaginary cutting line 330 extending laterally across the front edge 312 of the outer body 302. In some embodiments, the cutting teeth 320 and 328 may include protective coatings. In another embodiment, the distal planar surface 306 of the cutting assembly 30 includes protective coatings. The protective coatings may be lubricious, hydrophobic, and oleophobic. In one embodiment, the coating may be a non-volatile organic compound (non-VOC) silicate, non-polytetrafluoroethylene (non-PTFE), high-temperature release coating used for stainless steel and other metallic surfaces. Similar to the outer body 302, the moveable blade 324 is formed as a single monolithic component from a metallic material such as, for example, stainless steel. A cutting gap 350 (described above) is defined between the moveable blade 324 and the stationary blade 322.

The cutting assembly 30 also includes a biasing element—in this case, a spring 360—that is configured to bias the moveable blade 324 into engagement with the outer body 302 (and hence the stationary blade 322). The spring 360 includes a pair of legs 362 that provide a downward force on the moveable blade 324 and urge the blade 324 into contact with the outer body 302.

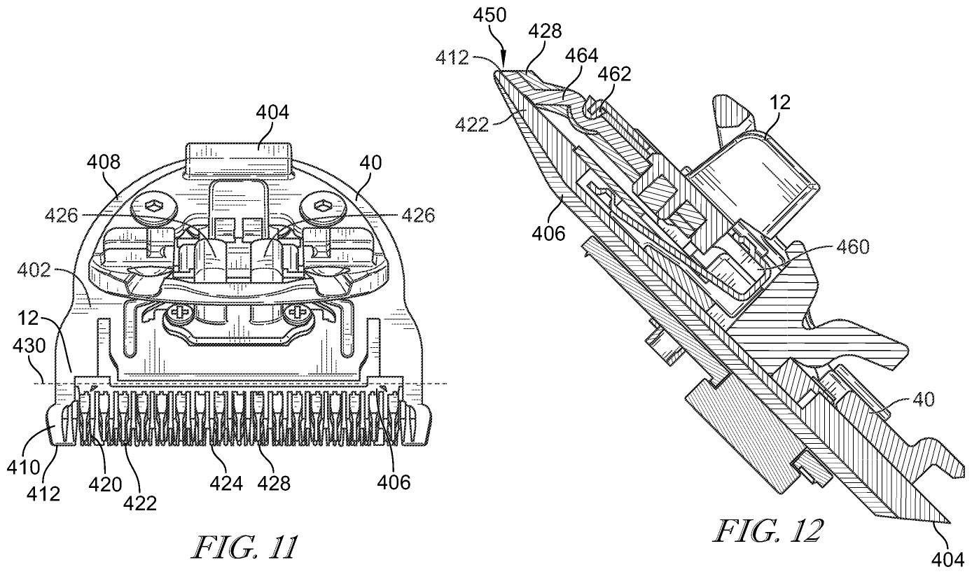

Referring now to FIGS. 11-12, the cutting assembly 40 is configured as a clipper. The cutting assembly 40 includes an outer body 402 that is sized to cover the distal receptacle 90 when the cutting assembly 40 is attached to the handle 14. In the illustrative embodiment, the outer body 402 is formed as a single monolithic component from a metallic material such as, for example, stainless steel. The outer body 402 includes a planar proximal surface 404, a planar distal surface 406, and a curved outer wall 408 that extends between the surfaces 404 and 406. The outer body 402 also includes a connecting surface 410 that extends away from the distal surface 406 to a front edge 412 of the outer body 402. In the illustrative embodiment, the connecting surface 410 is substantially planar, but it should be appreciated that in other embodiments it may be curved.

The outer body 402 of the assembly 400 also has a plurality of cutting teeth 420 defined along the front edge 412. Each cutting tooth 420 of the body 402 extends forward from a base to a pointed, cantilevered tip, and the teeth 420 cooperate to define a stationary blade 422, which is not moved by any of the electric motors during a trimming operation. The cutting assembly 40 also includes a moveable blade 424 having a cam follower 426 that is coupled to the cam 136 to move the moveable blade 424 back and forth in each direction along the first axis 64 with the primary motor 132 during the trimming operation. In the illustrative embodiment, the blade 424 is also attached to the adjustment mechanism 140, which may be operated by the user between trimming operations to move the moveable blade 424 back and forth in each direction along the second axis 68 adjust the separation or cutting gap between the blades 422 and 424 and hence adjust the amount of hair removed by the grooming device 10.

Similar to the stationary blade 422, the moveable blade 424 has a plurality of cutting teeth 428 defined extending forward from a base to a pointed, cantilevered tip. The tips of the cutting teeth 428 cooperate to define an imaginary cutting line 430 extending laterally across the front edge 412 of the outer body 402. In some embodiments, the cutting teeth 420 and 428 may include protective coatings. In another embodiment, the distal planar surface 406 of the cutting assembly 40 includes protective coatings. The protective coatings may be lubricious, hydrophobic, and oleophobic. In one embodiment, the coating may be a non-volatile organic compound (non-VOC) silicate, non-polytetrafluoroethylene (non-PTFE), high-temperature release coating used for stainless steel and other metallic surfaces. Similar to the outer body 402, the moveable blade 424 is formed as a single monolithic component from a metallic material such as, for example, stainless steel. A cutting gap 450 (described above) is defined between the moveable blade 424 and the stationary blade 422.

The cutting assembly 40 also includes a biasing element—in this case, a spring 460—that is configured to bias the moveable blade 424 into engagement with the outer body 402 (and hence the stationary blade 422). The spring 460 includes a pair of legs 462 that provide a downward force on the moveable blade 424 and urge the blade 424 into contact with the outer body 402.

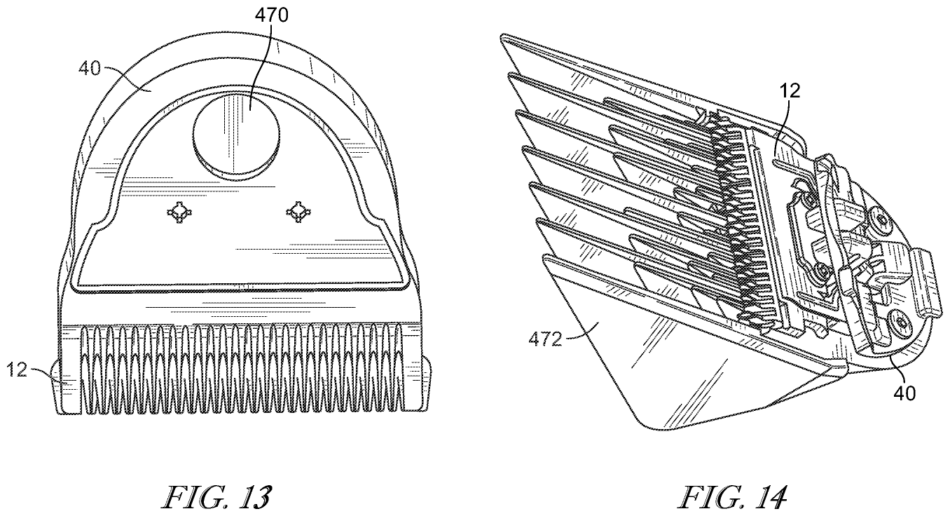

The cutting assembly 40 includes a magnetic connector 470, as illustrated in FIG. 13. For example, a surface of the cutting assembly 40 can be magnetic. At least one guard 472 is configured to couple to the magnetic connector 470. It will be appreciated that the grooming device 10 can include a plurality of guards 472 that interchangeably connect to the cutting assembly 40.

Any theory, mechanism of operation, proof, or finding stated herein is meant to further enhance understanding of principles of the present disclosure and is not intended to make the present disclosure in any way dependent upon such theory, mechanism of operation, illustrative embodiment, proof, or finding. It should be understood that while the use of the word preferable, preferably or preferred in the description above indicates that the feature so described can be more desirable, it nonetheless cannot be necessary and embodiments lacking the same can be contemplated as within the scope of the disclosure, that scope being defined by the claims that follow.

In reading the claims it is intended that when words such as “a,” “an,” “at least one,” “at least a portion” are used there is no intention to limit the claim to only one item unless specifically stated to the contrary in the claim. When the language “at least a portion” and/or “a portion” is used the item can include a portion and/or the entire item unless specifically stated to the contrary.

It should be understood that only selected embodiments have been shown and described and that all possible alternatives, modifications, aspects, combinations, principles, variations, and equivalents that come within the spirit of the disclosure as defined herein or by any of the following claims are desired to be protected. While embodiments of the disclosure have been illustrated and described in detail in the drawings and foregoing description, the same are to be considered as illustrative and not intended to be exhaustive or to limit the disclosure to the precise forms disclosed. Additional alternatives, modifications and variations can be apparent to those skilled in the art. Also, while multiple inventive aspects and principles can have been presented, they need not be utilized in combination, and many combinations of aspects and principles are possible in light of the various embodiments provided above.

1. An electric-powered modular grooming device comprising:
a handle,
an electrical circuit positioned in the handle and including a primary motor having a primary drive shaft, and
at least two cutting assemblies removeably coupled to the handle, the at least two cutting assemblies including a clipper and a trimmer, each of the at least two cutting assemblies comprising:
a stationary blade,
a moveable blade positioned on the stationary blade such that a cutting gap is defined between the moveable blade and the stationary blade, the moveable blade being configured to move along a first axis and a second axis extending orthogonal to the first axis, and
a drive mechanism connected between the primary drive shaft and the moveable blade to move the moveable blade relative to the stationary blade along the first axis,
wherein the electrical circuit includes an adjustment mechanism positioned in the handle, the adjustment mechanism including a secondary motor having a secondary drive shaft coupled to the moveable blade and operable to move the moveable blade along the second axis relative to the stationary blade to selectively change the size of the cutting gap.

2. The device of claim 1, wherein the electrical circuit includes at least one button configured to actuate the adjustment mechanism to move the moveable blade along the second axis.

3. The device of claim 1, wherein the size of the cutting gap is adjustable within a range of 0.0 mm to 2.5 mm.

4. The device of claim 3, wherein the size of the cutting gap is adjustable in 0.1 mm increments.

5. The device of claim 1, wherein the electrical circuit includes a display positioned in the handle to illustrate a number corresponding to the size of cutting gap.

6. The device of claim 1, further comprising:
at least one guard that couples to the cutting assembly, and
a magnetic connector positioned on the cutting assembly, wherein the at least one guard couples to the magnetic connector.

7. The device of claim 1, wherein the electrical circuit includes a motion detection device positioned in the handle, wherein the electrical circuit is activated when the motion detection device detects movement of the handle.

8. The device of claim 7, wherein the motion detection device is an accelerometer.

9. The device of claim 1, further comprising a battery pack positioned in the handle and electrically connected with the electrical circuit for providing electrical power to the electrical circuit.

10. An electric-powered modular grooming device comprising:
a handle,
a primary motor having a primary drive shaft, and
a plurality of cutting assemblies removeably coupled to the handle, each of the plurality of cutting assemblies comprising:
a first blade,
a second blade positioned on the first blade such that a cutting gap is defined between the second blade and the first blade, the second blade being configured to move in a first direction and a second direction that is different from the first direction, and
a drive mechanism connected between the primary drive shaft and the second blade to move the second blade relative to the first blade in the first direction,
an adjustment mechanism positioned in the handle, the adjustment mechanism including a secondary motor having a secondary drive shaft coupled to the second blade and operable to move the second blade in the second direction to selectively change the size of the cutting gap, and
at least one button configured to actuate the adjustment mechanism to move the second blade in the second direction to change the size of the cutting gap.

11. The device of claim 10, wherein the plurality of cutting assemblies includes a clipper and a trimmer.

12. The device of claim 10, wherein the size of the cutting gap is adjustable within a range of 0.0 mm to 2.5 mm.

13. The device of claim 12, wherein the size of the cutting gap is adjustable in 0.1 mm increments.

14. The device of claim 10, further comprising a display positioned in the handle to illustrate a number corresponding to the size of cutting gap.

15. The device of claim 10, further comprising:
at least one guard that couples to the cutting assembly, and
a magnetic connector positioned on the cutting assembly, wherein the at least one guard couples to the magnetic connector.

16. The device of claim 10, further comprising a motion detection device positioned in the handle, wherein the trimmer is activated when the motion detection device detects movement of the handle.

17. The device of claim 10, further comprising a battery pack positioned in the handle for providing electrical power to the trimmer.

18. The device of claim 17, further comprising a display in the handle to indicate an amount of electrical power remaining in the battery.

19. An electric-powered modular grooming device comprising:
a handle,
an electrical circuit positioned in the handle and including a primary motor having a primary drive shaft, and
a plurality of cutting assemblies that are interchangeably attachable to the handle, each of the plurality of cutting assemblies comprising:
a stationary blade,
a moveable blade positioned on the stationary blade such that a cutting gap is defined between the moveable blade and the stationary blade, the moveable blade being configured to move along a first axis and a second axis extending orthogonal to the first axis, and
a drive mechanism connected between the primary drive shaft and the moveable blade to move the moveable blade relative to the stationary blade along the first axis,
wherein the electrical circuit includes:
an adjustment mechanism positioned in the handle, the adjustment mechanism including a secondary motor having a secondary drive shaft coupled to the moveable blade and operable to move the moveable blade along the second axis relative to the stationary blade to selectively change the size of the cutting gap,
a first button configured to actuate the adjustment mechanism to move the moveable blade along the second axis to increase the size of the cutting gap, and
a second button configured to actuate the adjustment mechanism to move the moveable blade along the second axis to decrease the size of the cutting gap.

20. The device of claim 19, wherein the plurality of cutting assemblies includes a clipper and a trimmer.
